(19) United States
(12) Patent Application Publication
(10) Pub. No.: US 2011/0249816 A1
(43) Pub. Date: Oct. 13, 2011

(54) HYBRID KEY MANAGEMENT METHOD FOR ROBUST SCADA SYSTEMS AND SESSION KEY GENERATION METHOD

(75) Inventors: Donghyun Choi, Gyeonggi-do (KR); Hanjae Jeong, Gyeonggi-do (KR); Dongho Won, Gyeonggi-do (KR); Seungjoo Kim, Gyeonggi-do (KR); Jae-Cheol Ryou, Daejeon (KR)

(73) Assignee: The Industry & Academic Cooperation in Chungnam National University (IAC), Daejeon (KR)

(21) Appl. No.: 12/874,802

(22) Filed: Sep. 2, 2010

(30) Foreign Application Priority Data
Apr. 8, 2010 (KR) 10-2010-0032408

(51) Int. Cl. H04L 9/08

(52) U.S. Cl. 380/279

(57) ABSTRACT

Disclosed is a hybrid key management method for a supervisory control and data acquisition (SCADA) system in which a master terminal unit (MTU), a plurality of sub-master terminal units (sub-MTUs), and a plurality of remote terminal units (RTUs) are sequentially and hierarchically structured, the hybrid key management method comprising the steps of: (a) creating, by the MTU and the sub-MTUs, their own secret numbers and making and exchanging digital signatures; (b) creating, by the MTU, group keys; and (c) distributing, by the MTU, the group keys to the sub-MTUs and encrypting and decrypting the group keys using the secret numbers.

### CROSS-REFERENCE TO RELATED APPLICATION

This application claims priority to and the benefit of Korean Patent Application No. 2010-0032408 filed on Apr. 8, 2010, the disclosure of which is incorporated herein by reference in its entirety.

### BACKGROUND

1. Field of the Invention

The invention relates to a hybrid key management method for robust SCADA systems in which group keys are created and are distributed using digital signatures in a SCADA system in which a master terminal unit (MTU), a plurality of sub-master terminal units (sub-MTUs), and a plurality of remote terminal units (RTUs) are sequentially and hierarchically structured, and a session key generation method.

The invention also relates to a hybrid key management method for robust SCADA systems in which public key based encryption is applied between an MTU and sub-MTUs and high performance symmetric key based encryption is applied between sub-MTUs and RTUS, and a session key generation method.

2. Discussion of Related Art

Modern industrial facilities such as oil refineries, electric power generating plants, and manufacturing facilities generally have command and control systems. These industrial command and control systems are commonly referred to as Supervisory Control and Data Acquisition (SCADA) systems.

As demand for connecting SCADA systems to open networks increases, SCADA systems have become exposed to a wide range of network security problems. If a SCADA system is damaged through an attack, this system can have a widespread negative effect upon society. To prevent such attacks, many researchers have been studying the security of SCADA systems.

Many researchers have proposed key management schemes for SCADA systems. Key establishment for SCADA systems (SKE) and a SCADA key management architecture (SKMA) have both been proposed, and two schemes were recently proposed—Advanced SCADA Key Management Architecture (ASKMA) and Advanced SCADA Key Management Architecture+ (ASKMA+).

The ASKMA scheme has been proposed in Korean Patent Application No. 10-2010-0006103 (hereinafter, Prior Art 1), filed by the applicant of the present invention, titled “Efficient Key Management Method for SCADA Communications”. Prior Art 1 relates to a shared key management method for SCADA communications in which shared keys of a group key are generated in a tree structure and remote terminal units or sub master terminal units share the shared keys of their ancestor nodes and descendent nodes of the nodes corresponding to themselves, and a session key generation method. In particular, the group keys of a SCADA system is generated in a binary tree structure, and all the shared keys of the on-path nodes from an intermediate node to a root node are updated if the shared key of the intermediate key is updated. The shared keys of the on-path nodes are updated by their own shared keys and the shared keys of off-path child nodes.

However, previous studies do not appropriately consider availability. That is, they do not have a solution for the case when the main device breaks down. In addition, since many SCADA devices are remote from the control center, they are physically insecure. Therefore, the devices need to periodically update the security keys stored therein. However, the computation and communication costs of this update process increase as both the number of vulnerable devices and keys increase, so SCADA systems need to reduce the number of keys transmitted for security and efficiency.

Hereinafter, the cryptographic security requirements for SCADA systems will be discussed in more detail. They have been rebuilt based on standards and reports.

1) Access control: A SCADA system should uniquely identify and authenticate organizational users and devices.

2) Availability: The availability of a SCADA system is more important than confidentiality, because an unavailable SCADA system can cause physical damage or threaten human life. Usually, SCADA systems employ backup devices, because they should be designed to be always on. If the main device breaks down, it should be replaced with a backup device as soon as possible.

3) Confidentiality: The data transmitted between nodes should be protected by encryption.

4) Cryptographic key establishment and management: When cryptography is required and employed within a control system, the organization establishes and manages cryptographic keys using automated mechanisms with supporting procedures or manual procedures.
Broadcasting/Multicasting: Most SCADA systems include some form of broadcast capability. Because the SCADA system can send important messages such as “emergency shutdown” by broadcast capability, the broadcast messages should be protected.
Backward secrecy (BS): Guarantees that a passive adversary who knows a subset of group keys cannot discover preceding group keys.
Group key secrecy (GKS): Guarantees that it is computationally infeasible for an adversary to discover any group key.
Forward secrecy (FS): Guarantees that a passive adversary who knows a contiguous subset of old group keys cannot discover subsequent group keys.
Key freshness: RTUs are remote from the control center. The location of the RTU makes them physically insecure, so the keys in RTUs should be updated within a reasonable amount of time.
Perfect forward secrecy (PFS): Perfect forward secrecy is the property that ensures that a session key derived from a set of long-term public and private keys will not be compromised if one of the private keys is compromised in the future.

5) Integrity: It is critical that messages between nodes are not tampered with, and that no new message is inserted since message modification and injection can cause physical damage. Therefore, the SCADA system should ensure the integrity of the transmitted message.

6) Public key infrastructure: The organization issues public key certificates under an appropriate certificate policy or obtains public key certificates under an appropriate certificate policy from an approved service provider.

7) Number of keys: Since many SCADA system devices are remote from the control center, they are physically insecure. Therefore, the devices need to periodically update the security keys stored therein. In addition, if a device has many keys and the device is compromised, other devices which have those keys also become vulnerable. Therefore, each device which has keys must perform the update process. Since the computation and communication costs of this update process increase as both the number of vulnerable devices and keys increases, SCADA systems need to reduce the number of keys stored on each device for security and efficiency.

Hereinafter, the performance requirements and network configuration requirements of SCADA systems will be described in more detail.

First, a SCADA system needs to interact with devices in real time. Conventionally, a proposed architecture for SCADA communications must match the shortest time delay requirement of no more than 0.540 seconds.

Generally, a SCADA communication link operates at low speeds such as 300 to 19200 baud. In the modbus implementation guide, the default baud rate is 19200 and if that cannot be implemented then the default baud rate is 9600. Therefore, it is preferable to assume a required rate of 9600 baud.

When the SCADA system was first developed, the system architecture was based on a mainframe. Remote devices communicated directly with the MTU by serial data transmission. The second generation SCADA systems took advantage of developments and improvements in systems miniaturization and local area networking (LAN) technology to distribute the processing load across multiple systems. Thus, when a local MTU or human machine interface (HMI) malfunctioned, the device could be promptly replaced. Therefore, it is preferable to assume that a SCADA system's topology is second generation.

### SUMMARY OF THE INVENTION

The prevent invention has been made in an effort to solve the above-described problems associated with the prior art, and an object of the invention is to provide a hybrid key management method for robust SCADA systems in which group keys are created and are distributed using digital signatures in a SCADA system in which a master terminal unit (MTU), a plurality of sub-master terminal units (sub-MTUs), and a plurality of remote terminal units (RTUs) are sequentially and hierarchically structured, and a session key generation method.

It is another object of the invention to provide a hybrid key management method for robust SCADA systems in which public key based encryption is applied between an MTU and sub-MTUs and high performance symmetric key based encryption is applied between sub-MTUs and RTUS, and a session key generation method.

According to one aspect of the invention, there is provided a hybrid key management method for a supervisory control and data acquisition (SCADA) system in which a master terminal unit (MTU), a plurality of sub-master terminal units (sub-MTUs), and a plurality of remote terminal units (RTUs) are sequentially and hierarchically structured, the hybrid key management method comprising the steps of: (a) creating, by the MTU and the sub-MTUs, their own secret numbers and making and exchanging digital signatures; (b) creating, by the MTU, group keys; and (c) distributing, by the MTU, the group keys to the sub-MTUs and encrypting and decrypting the group keys using the secret numbers.

Step (c) may comprise the steps of: (c1) raising, by the MTU, the group keys to the power of the product of its own secret key and the secret keys of the sub-MTUs and transmitting the raised group keys to the sub-MTUs; and (c2) decreasing, by the sub-MTUs, the raised group keys in proportion to the inverse power of the product of their own secret keys and the secret key of the MTU to obtain the group keys.

The hybrid key management method may further comprise the step of: (d) distributing, upon joining of a new sub-MTU (hereinafter, joining terminal), a group key to the joining terminal. Here, step (d) may comprise the steps of: (d1) creating, by the joining terminal, its own secret number; (d2) encrypting, by the MTU and the joining terminal, their secret numbers using a certificate and exchanging the secret numbers; and (d3) transmitting, by the MTU, the group key to the joining terminal using the same method as step (c).

The hybrid key management method may further comprise the step of: (e) redistributing, upon leaving of at least one sub-MTU, the group keys. Here, step (e) comprises the step of: (e1) recreating the group keys by the MTU; and (e2) transmitting, by the MTU, the recreated group keys to the sub-MTUs which have not left according to the same method as step (c).

The hybrid key management method may further comprise the step of: (f) replacing, upon exchange of the at least one sub-MTU (hereinafter, exchanged terminal) with another sub-terminal, the group key. Here, step (f) may comprise the steps of: (f1) recreating the group keys and transmitting the recreated group keys to the sub-MTUs that have not been exchanged according to the same method as step (e); and (f2) transmitting the recreated group keys to the exchanged terminal by the MTU according to the same method as step (d).

The terminals may verify the secret numbers of their counterparts using the certificates of their counterparts.

The secret numbers may be created by raising generators of a subgroup of an algebraic group to the power of random numbers which are created at random and pertain to the algebraic group.

The secret numbers may be created by applying Equation 1.

Secret number=g^{ri} mod p, Equation 1
where rᵢεZ_{q} is a random number of a terminal (i=0 in case of an MTU and i=[1,m] (m is the number of sub-MTUs) in case of a sub-MTU), g is a generator of a subgroup of an order q, and p is a prime number satisfying p=k·q+1 for a given small number kεN.

An intermediate key IKᵢ may be obtained by raising a group key K_{g} to the power of g^{r}^{ₒ}^{r}^{ᵢ} in Equation 2 and a group key Kg is obtained by decreasing a group key (or intermediate key) IKᵢ to the inverse power of g^{r}^{ₒ}^{r}^{ᵢ} in Equation 3.

IKᵢ=(K_{g})^{g}^{^{r}}^{ₒ}^{^{r}}^{ᵢ} mod p Equation 2

K_{g}=K^{g}^{^{r}}^{ₒ}^{^{r}}^{ᵢ}_{/g}^{^{r}}^{ₒ}^{^{r}}^{ᵢ}_{g} mod p Equation 3

The group keys may have a tree structure. The tree structure may have a tree of an n^{th} order from the root node corresponding to the MTU and the intermediate nodes corresponding to the sub-MTUs. The descendent nodes of the intermediate nodes may have binary trees. The leaf nodes of the binary trees may correspond to the RTUs connected to the sub-MTUs of the intermediate nodes.

According to another aspect of the invention, there is provided a session key generation method using a hybrid key of a supervisory control and data acquisition (SCADA) system in which a master terminal unit (MTU), a plurality of sub-master terminal units (sub-MTUs), and a plurality of remote terminal units (RTUs) are sequentially and hierarchically structured, the session key generation method comprising the steps of: (a) creating group keys in a tree structure by the MTU, the tree structure having a tree of an n^{th} order from the root node corresponding to the MTU and intermediate nodes corresponding to the sub-MTUs, child nodes of the intermediate nodes having binary trees, and leaf nodes of the binary trees corresponding to the RTUs connected to the sub-MTUs of the intermediate nodes; (b) distributing the group keys to the sub-MTUs and the RTUs by the MTU and receiving and storing, by the sub-MTUs and the RTUs, the group keys of the ancestor nodes and descendent nodes of the nodes corresponding thereto; (c) selecting a node of the tree structure and creating a session key for communications with a sub-MTU or an RTU corresponding to the descendent node of the selected node as a group key of the selected node; and (d) in step (b), creating, by the MTU and the sub-MTUs, their secret numbers and digitally singing and exchanging the secret numbers, the group keys being encrypted and decrypted by the secret numbers to be distributed.

Session keys may be created by hashing values obtained by combining the group keys, timestamps, and sequence numbers.

According to the invention, a replace protocol which is available and by which the number of keys stored in an MTU is reduced can be supported by applying public key based encryption between the MTU and sub-MTUs and by applying high performance symmetric key based encryption between sub-MTUs and RTUS

### BRIEF DESCRIPTION OF THE DRAWINGS

The above and other objects, features and advantages of the invention will become more apparent to those of ordinary skill in the art by describing in detail an exemplary embodiment thereof with reference to the accompanying drawings, in which:

FIG. 1 is a view illustrating an exemplary SCADA system for carrying out the invention;

FIG. 2 is a view illustrating an exemplary structure of a SCADA system according to an embodiment of the invention;

FIG. 3 is a flowchart of a hybrid key management method for a SCADA system according to an embodiment of the invention; FIG. 4 is a view exemplifying a tree structure of group keys created according to an embodiment of the invention;

FIG. 5 is an illustrative example of a join protocol according to an embodiment of the invention;

FIG. 6 is an illustrative example of a leave protocol according to an embodiment of the invention;

FIG. 7 is an illustrative example of a replace protocol according to an embodiment of the invention;

FIGS. 8A and 8B are views exemplifying a total time delay according to an embodiment of the invention; and

FIGS. 9A to 9C are views comparing the number of keys stored in an MTU and the total computation time.

### DETAILED DESCRIPTION OF EXEMPLARY EMBODIMENTS

Hereinafter, exemplary embodiments of the invention will be described below in detail with reference to the accompanying drawings.

In the description of the embodiments, the same elements are denoted by the same reference numerals and will not be repeatedly described.

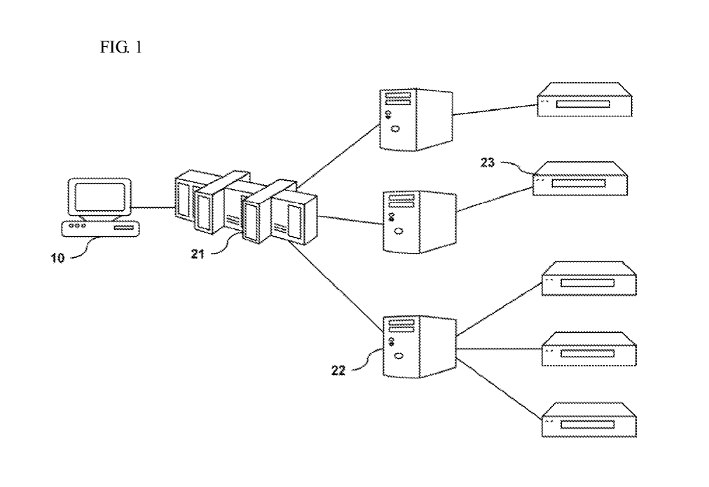

First, an exemplary SCADA system for carrying out the invention will be described with reference to FIG. 1.

As can be seen in FIG. 1, the SCADA system for carrying out the invention includes a human-machine interface (HMI) 10, a master terminal unit (MTU) 21, a plurality of sub-master terminal units (sub-MTUs) 22, and a plurality of remote terminal units (RTUs) 23. In particular, the MTU 21, the sub-MTUs 22, and the RTUs 23 have a sequentially hierarchical structure.

The HMI 10 shows process data of an infrastructure facility to a manager. The manager monitors and controls the infrastructure facility through the HMI 10. For this purpose, the HMI 10 includes a terminal unit having a computing function.

The RTUs 23 are terminal units which are installed directly at infrastructure facilities to collect and transmit process data and perform control instructions. Generally, the infrastructure facilities to which the SCADA system is applied are distributed across a wide range of regions, so the RTUs 23 are also spaced apart from each other.

The sub-MTUs 22 communicate with specific RTUs 23 and control the RTUs 23. The MTU 21 collects and controls process data as a whole. That is, the MTU 21 controls the sub-MTUs 22 and monitors and controls the RTUs 23 through the sub-MTUs 22.

Session keys are used to allow the MTU 21, the sub-MTUs 22, and the RTUs 23 to perform encrypted communications with each other. That is, a session key is generated between a transmitting terminal and a receiving terminal and then is shared by the terminals. The transmitting terminal encrypts a target message with the session key and then transmits it, and the receiving terminal receives the encrypted message and then decrypts it with the session key.

The session keys are used in specific sessions and a new session key is used for each session. Even if a session key is exposed, other sessions are secure. However, the session keys are generated using keys shared by the terminals. That is, the session keys are generated by hashing the keys shared by the terminals and timestamps. Thus, it is most important to manage keys for secure communications.

In the hybrid key management method for robust SCADA systems according to the embodiment of the invention, keys are managed in two hierarchies as a whole by the MTU 21. That is, according to the embodiment of the invention, the MTU 21 generates and transmits a group key to the sub-MTUs 22. The MTU 21 mainly manages the common key.

Meanwhile, if a sub-MTU 22 is deleted from or added to the SCADA system, all the keys shared by the sub-MTUs 22 should be updated to protect the keys. Thus, the MTU 21 updates the keys and transmits them to the sub-MTUs 22.

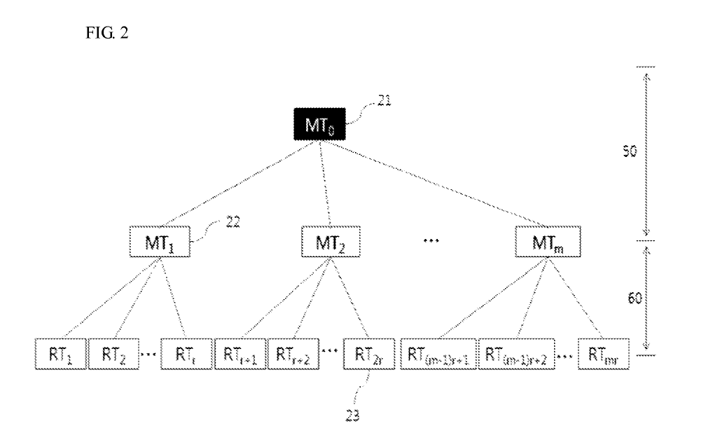

Next, the notations and system structure for describing the hybrid key management method for SCADA systems according to the embodiment of the invention will be described with reference to FIG. 2.

The following notations are used throughout the specification.
m: the number of sub-MTUs
r: the maximum number of RTUs per sub-MTU
GM: a nonempty set of nodes. This set is divided into two disjoint subsets MT and RT, i.e. GM=MT RT
RT: RT={RT₁, . . . , RT_{m·r}} is the set of RTUs
MT: MT={MT0, . . . , MTm} is the nonempty set of an MTU or sub-MTUs
g: generator of the subgroup of an order q
p: a prime number such that p=kq+1 for some small k N
q: the order of the algebraic group
rᵢ: MTᵢ's random number rᵢ Z_{q}
IKi: MTi's intermediate key
K^{k}_{k,j}: MTₖ's jₜₕ key at a level i in a binary tree

As can be seen in FIG. 2, a CKD protocol, an Ioulus framework and a logical key structure are implemented. The proposed protocol has two parts MTs and RTs. MTs make a group key by the CKD protocol and RTs are constructed in a logical hierarchy structure.

Each RTᵢ knows keys from a leaf node to an intermediate node as shown in FIG. 2. Each MTᵢ (i≠0) knows all keys which are on the path from the leaf node to the root node. The MT and RT are connected through the Iolus framework. The MT₀ (MTU) plays the role of a group security controller (GSC). Thus, the MT₀ manages the entire group and the group key between the MT₀ and MTᵢ (1≦i≦m). The MTᵢ (1≦i≦m) plays the role of a group security intermediary (GSI). It manages the subgroup key of its subgroup consisting of rRTs. The architecture of RT and connection of RT and MT are the same as in the ASKMA+protocol.

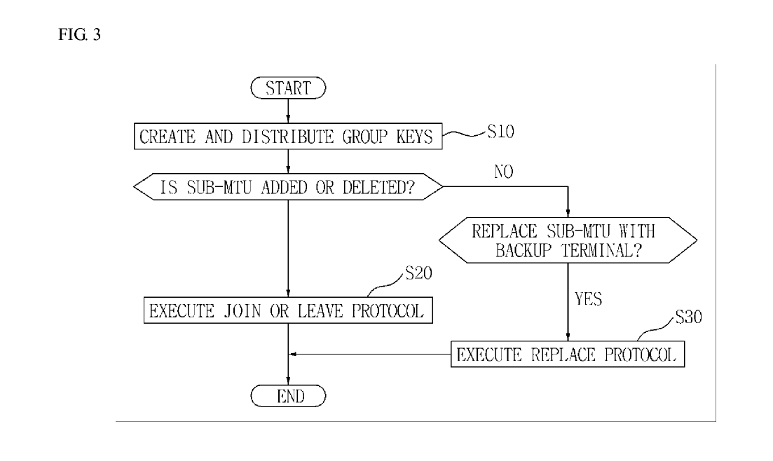

Now, the hybrid key management method for SCADA systems according to the embodiment of the invention will be described with reference to FIGS. 3 to 6.

The key management method according to the embodiment of the invention comprises an initialization step S10, a step S20 of updating keys when a sub-MTU 22 is added or deleted, a step S30 of updating keys when the sub-MTU 22 or the MTU 21 is replaced with reserve equipment.

First, the MTU 21 creates a tree structure of keys (S10). As can be seen in FIG. 4, the root node 31 of the tree structure corresponds to the MTU 21. The intermediate nodes 32 correspond to the sub-MTUs 22, and the leaf nodes 34 correspond to the RTUs 23.

Meanwhile, an n^{th} order tree is provided between the root node 31 and the intermediate nodes 32.

A binary tree is provided between each intermediate node 32 and its leaf nodes 34. The nodes between the intermediate nodes 32 and the leaf nodes 34 will be called “general nodes” 33 below.

An example of a method of creating a group key in a tree structure is as follows.

First, the MTU 21 selects a random number r₀ computes g^{r}^{ₒ} mod p|, digitally signs it, and transmits it to the sub-MTUs 22. After each sub-MTU 22 which has received the message checks the validity of the digital signature and selects a random number rᵢ if the digital signature is valid, it computes g^{r}^{ᵢ} mod p, digitally signs it, and transmits it to the MTU 21. Here, i is the index number of a sub-MTU 22 and rᵢ is a random number which satisfies rᵢεZ_{q}. Here, q is the order of an algebraic group and p is a prime number satisfying p=kq+1 for a small positive integer K.

Next, the sub-MTUs 22 and the MTU 21 compute g^{r}^{₀}^{r}^{ᵢ} mod p (iε[i,m]). Here, m represents the number of sub-MTUs 22.

Next, the MTU 21 checks the validity of the digital signature, selects a group key K_{g}, computes IKᵢ=K^{g}^{^{r}}^{₀}^{^{r}}^{ᵢ}_{g} mod p|(iε[i,m]), and digitally signs it. The MTU 21 and the sub-MTUs 22 can compute them in advance.

Next, the MTU 21 digitally signs IKᵢ(iε[i,m]) and transmits it to the sub-MTUs MTUs 22. The sub-MTUs 22 compute K_{g}=K^{g}^{^{r}}^{₀}^{^{r}}^{ᵢ}^{/g}^{^{r}}^{₀}^{^{r}}^{ᵢ}_{g} mod p(iε[i,m]) to obtain group keys K_{g}.

Next, details of the step S20 of updating keys when a sub-MTU 22 is deleted from and added to the tree structure are as follows.

For the m sub-MTUs 22, a method of having (m+1)th sub-MTU 22 newly join the group is as follows.

First, the MTU 21 digitally signs g^{r}^{ₚ} mod p which has been created in step 10, and then transmits it to a newly joining sub-terminal 22. After the sub-MTU 22 which has received the message checks the validity of the digital signature, if the digital signature is valid, the sub-MTU 22 selects a random number rₘ₊₁, computes g^{r}^{ₘ₊₁} mod p, digitally signs it, and transmits it to the MTU 21. Here, m+1 is the index number of the newly joining sub-MTU 22.

Next, the newly joining sub-MTU 22 and the MTU 21 compute g^{r}^{ₒ}^{r}^{ₘ₊₁} mod p.

Next, the MTU 21 checks the validity of the digital signature, and if the digital signature is valid, the MTU 21 selects a new group key K′_{g} at random, computes IK′ᵢ=(K′_{g})^{g}^{^{r}}^{₀}^{^{r}}^{ᵢ} mod p (iε[i,m]), and digitally signs it.

Next, the MTU 21 digitally signs IK′ᵢ(iε[i,m]) and transmits it to the prior sub-MTU 22 and the newly joining sub-MTU 22. The sub-MTU 22 computes K′_{g}=K′^{g}^{^{r}}^{₀}^{^{r}}^{ᵢ}^{/g}^{^{r}}^{₀}^{^{r}}^{ᵢ}_{g} mod p to obtain K′_{g}.

Although the random value rᵢ basically should be updated all the time, rᵢ is repeatedly used for efficiency as in “session cache mode” of SSL.

While the initializing protocol reuses rᵢS, since it uses exponentials to compute IK′, the group members cannot know g^{rori} of other group members. This can be applied to leave protocols or replace protocols as well as join protocols.

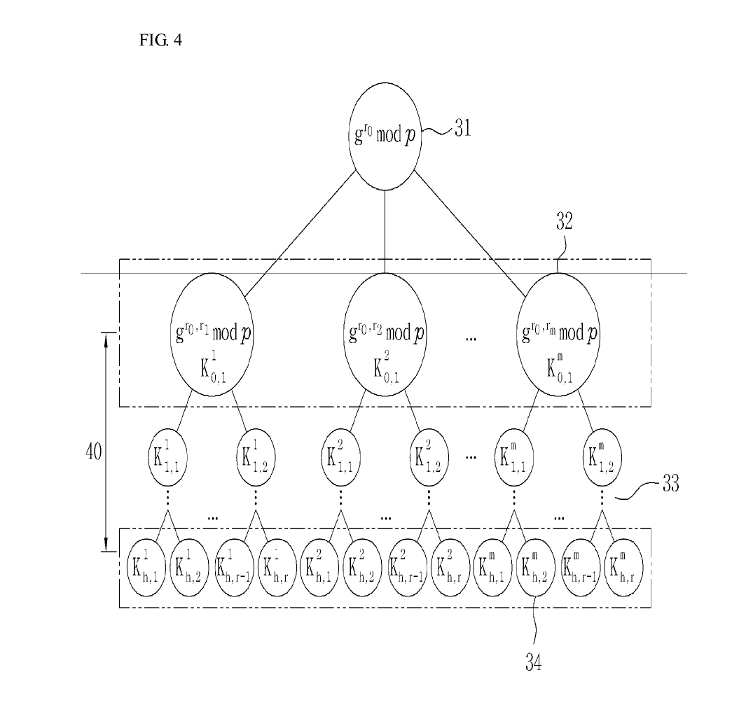

FIG. 5 shows a simple illustrative example of a join protocol. Here, a new sub-MTU is MT₅ and m is 4. A detail of this example is as follows.
Step 1: MT₀ broadcasts g^{r}^{₀} mod p generated in the initialization step to a new unit MT₅ with a digital signature.
Step 2: The new unit MT₅ checks the validity of the digital signature, selects a random number r₅, computes g^{r}^{₅} mod p|, and sends it to MT₀ with a digital signature.
Step 3: The new unit MT₅ and MT₀ compute g^{r}^{₀}^{r}^{₅} mod p.
Step 4: MT0 checks the validity of the digital signatures, generates a group key K_{g}′ which is a random value, computes IKᵢ′=(K′_{g})^{g}^{^{rori}}mod p (iε[1,5]), and signs it.
Step 5: MT₀ sends IKᵢ′ (iε[1,5]) back to MTᵢ with a digital signature.
Step 6: Upon receipt of the message, each member MTᵢ(iε[1,5]) computes K_{g}′=K_{g}^{g}^{^{rori}}^{/g}^{^{rori}}mod p.

Next, a method of updating the keys when the j^{th} sub-MTU 22 leaves a group consisting of m sub-MTUs 22 is as follows.

First, the MTU 21 selects a new group key K_{g}′ at random, computes IK′ᵢ=(K′_{g})^{g}^{^{r}}^{₀}^{^{r}}^{ᵢ} mod p (i≠j and iε[1,m]), and digitally signs it.

Next, the MTU 21 digitally signs IKᵢ′, and transmits the sub-MTUs 22 other than the leaving sub-MTU 22. The sub-MTU 22 computes K′_{g}=(K′_{g})^{g}^{^{r}}^{₀}^{^{r}}^{ᵢ}^{/g}^{^{r}}^{₀}^{^{r}}^{ᵢ} mod p|(i≠j and iε[1,m]) to obtain K_{g}′.

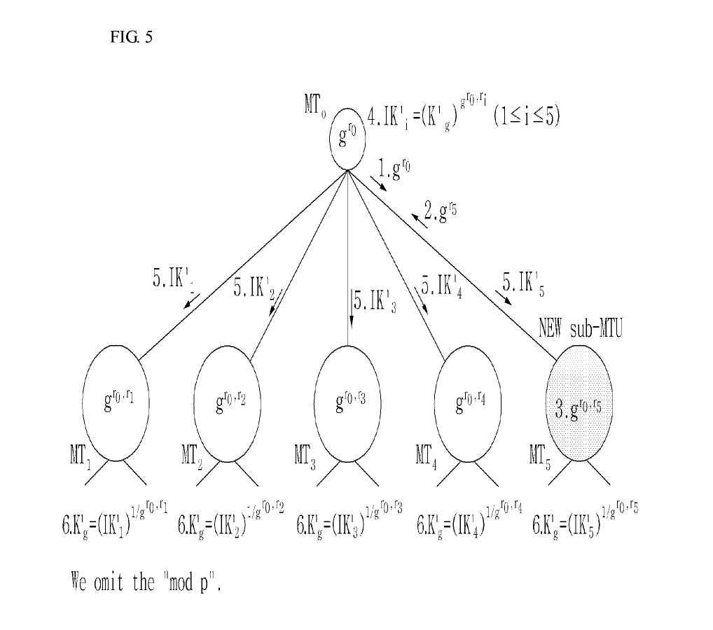

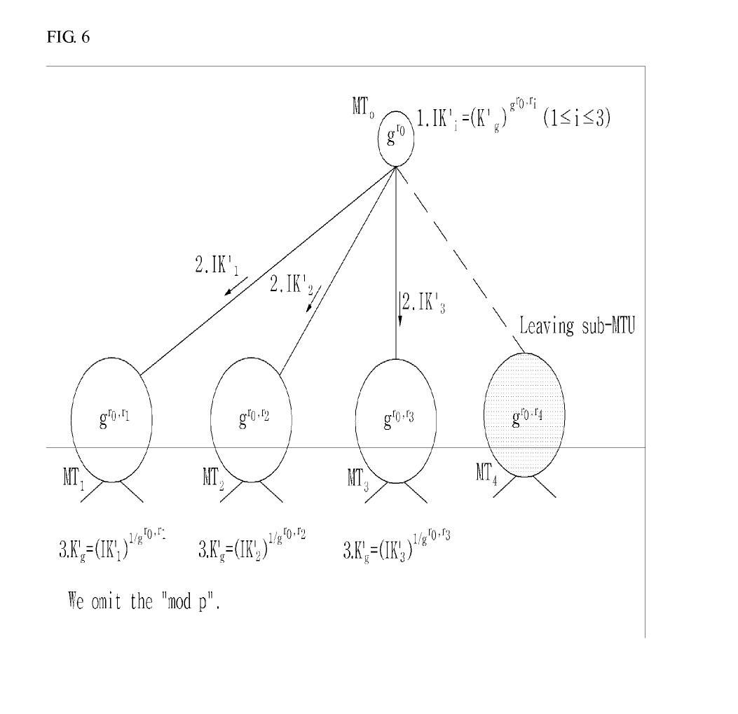

FIG. 6 shows a simple illustrative example of a leave protocol, and a leaving sub-MTU is MT₄ and m is 4. Details of the example are as follows.
Step 1: MT₀ generates a new group key K_{g}′, computes IK′ᵢ=(K′_{g})^{g}^{^{r}}^{₀}^{^{r}}^{ᵢ} mod p(i≠j and iε[1,3]), and signs it.
Step 2: MT₀ sends IKᵢ′ (iε[1,3]) to MTᵢ with a digital signature.
Step 3: Upon receipt of the message, each member MTᵢ(i≠j and i [1,3]) computes K′_{g}=(K′_{g})^{g}^{^{r}}^{₀}^{^{r}}^{ᵢ} mod p.

The RTU leave protocol performs the same procedure as the ASKMA+protocol.

Next, a step S30 of updating keys when a sub-MTU 22 or the MTU 21 is replaced with backup equipment is as follows.

A replace protocol for replacement with backup equipment is provided to support the availability. If some units of the SCADA system break down, they should be replaced with backup equipment. In this case, the leave protocol and the join protocol are simultaneously performed. Thus, the replace protocol is a combination of the leave protocol and the join protocol.

If a sub-MTU MTₐ breaks down, MTₐ should be switched to a backup sub-MTU. A method of updating keys when a sub-MTU 22 (i=n) is replaced with backup equipment will be described.

First, the MTU 21 selects a new group key K_{g}′ at random, computes K′_{g}=K′^{g}^{^{r}}^{₀}^{^{r}}^{ᵢ}^{/g}^{^{r}}^{₀}^{^{r}}^{ᵢ}_{g} mod p (i≠j and i [1,m]), and signs it.

Next, the MTU 21 digitally signs IKᵢ′ and transmits it to the sub-terminals 22 except for the replaced sub-terminal 22. The sub-MTU 22 computes K′_{g}=K′^{g}^{^{r}}^{₀}^{^{r}}^{ᵢ}^{/g}^{^{r}}^{₀}^{^{r}}^{ᵢ}_{g} mod p (i≠j and iε[1, m]) to obtain the group key K_{g}′.

Next, the MTU 21 digitally signs g^{r}^{₀} mod p and transmits it to a backup sub-MTU 22 which will replace the sub-MTU 22. The backup sub-MTU 22 which has received the message checks the validity of the digital signature, and if the digital signature is valid, the backup sub-MTU 22 selects a new random number r′ₙ, computes g^{r′}^{ₙ} mod p, digitally signs it, and transmits it to the MTU 21.

Next, the backup sub-MTU 22 and the MTU 21 compute g^{r}^{₀}^{r′}^{ₙ} mod p

Next, the MTU 21 checks the validity of the digital signature, and if the digital signature is valid, the MTU 21 computes |IK′ₙ=(K′_{g})^{g}^{^{r}}^{₀}^{^{r′}}^{ₙ} mod p and digitally signs it.

Next, the MTU 21 digitally signs IK′ₙ and transmits it to the prior sub-MTU 22 and the new sub-MTU 22. The sub-MTU 22 computes K′_{g}=K′^{g}^{^{r}}^{₀}^{^{r′}}^{ₙ}^{/g}^{^{r}}^{₀}^{^{r′}}^{ₙ}_{g} mod p to obtain K′_{g}.

If the MTU 21 is replaced, the initialization step S10 is performed again.

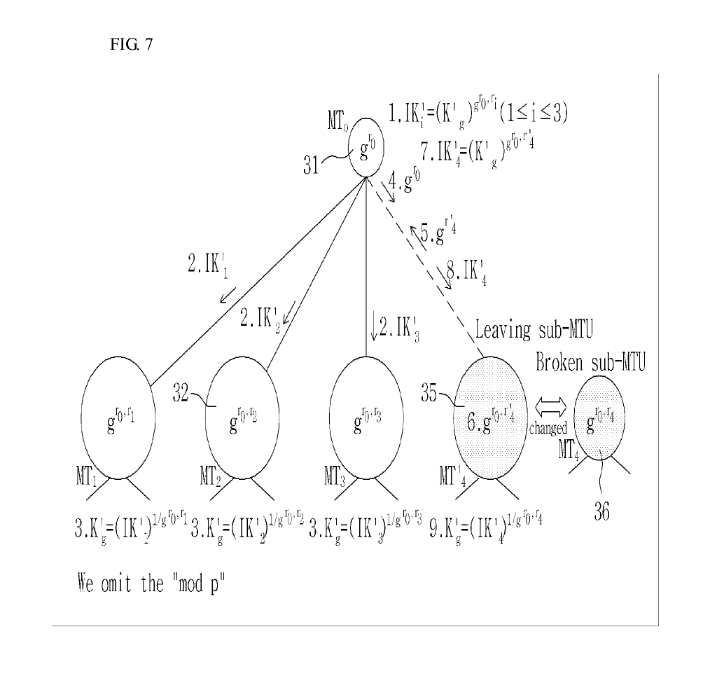

FIG. 7 shows a simple illustrative example of a replace protocol, and the broken unit is MT₄ and m is 4. Details of the example are as follows.
Step 1: MT₀ generates a new group key K′g, computes IK′ᵢ=(K′_{g})^{g}^{^{rori}} mod p|(i [1,3]), and signs it.
Step 2: MT₀ sends (i [1,3]) to MTi with a digital signature.
Step 3: Upon receipt of the message, each member MTᵢ (i [1,3]) computes

$${K}_{g}^{′} = {( {K}_{g}^{′} )}^{{g}^{{g}^{rori} / {g}^{rori}}} mod p .$$

Step 4: MT0 sends g^{r}^{₀} mod p to the reserve sub-MTU MT′₄ with a digital signature.
Step 5: MT′₄ checks the validity of the digital signature, selects a new random number r′₄, computes g^{4′}^{₄} mod p, and sends it to the MT₀ with a digital signature.
Step 6: MT′₄ and MT₀ compute g^{r}^{₀}^{r′}^{₄} mod p|.
Step 7: MT₀ checks the validity of the digital signatures, generates a new group key K′g, computes IK′₄=(K_{g})^{g}^{^{r0r4′}}mod p, and signs it.
Step 8: MT₀ sends IK′₄ to MT′₄ with a digital signature.
Step 9: Upon receipt of the message, MT′4 computes

$${K}_{g}^{′} = {{K}_{g}^{′}}^{{g}^{{g}^{ror {4}^{′}} / {g}^{ror {4}^{′}}}} mod p .$$

Next, a method of generating a session key according to the invention will be described.

In this subsection, the data encryption algorithms for unicast, broadcast, and multicast are presented. For the freshness of the session key, a time variant parameter (TVP) is used. The TVP is a combination of a timestamp and a sequence number.

That is, the session keys is generated using a key shared by terminals which are to be communicated with each other. Thus, the generation, storage, and updating of the key follows the above-described method.

In unicast, the session key for data encryption is generated in the following equation.

SK_{U}=H(K_{h,j}^{k}, TVP) Equation 1

Here, K_{h,j}^{k} is a leaf node′s key where h is a height of the tree. The data is encrypted with the session key SK_{U}.

In broadcast and multicast, the session key for data encryption should be generated using shared information by every member. The generation of the session key for broadcast and multicast uses the following equation.

SK_{b}=H(K_{g}, TVP)| Equation 2

Here, K_{g} is a shared key among group members. That is, K_{g} is a shared key among all group members or some members of the group.

Thus, an encryption session may be set through the key having the structure 30.

Next, the period to update the keys of the RTUs according to the invention will be described.

Since RTUs are generally remote from the control center, they are physically insecure. Therefore, the keys stored in the RTUs need to be periodically updated. If the key update frequency is too short, a time delay in SCADA communications needs to be increased. Thus, a suitable key update period, which satisfies communication efficiency and security requirements, needs to be found. Thus, QoS function is defined in Equation 3 to find the period.

QoS=Ci+Si Equation 3

CI and SI stand for communication index and security index. CI is computed based on the time delay caused by updating the keys in the RTUs. Assume that T is the period of communication in the SCADA system and δ is the time delay caused by updating keys, CI is computed in Equation 4.

$$CI = \frac{T - δ}{T} \qquad Equation 4$$

Since the period to update the keys is inversely proportional to δ, Equation 4 is modified to Equation 5.

$$C I = \frac{T - δ}{T} = \frac{T - k / {t}_{p}}{T} \qquad Equation 5$$

Here, k is a constant and tₚ is the time between updating the current and next keys.

SI is calculated by the probability of a successful attack upon the RTUs. Since a successful attack upon the RTUs is recognized as an independent event in real life, a Poisson process may be employed to express the event.

$$\frac{{( λ t )}^{n}}{n !} , n = 0 , 1 , … \qquad Equation 6$$

Here, n is the number of the events during the time(=t), and λ is the mean of the number of the successful attacks upon the RTUs. The security goal of the invention is that a successful attack upon the key in the RTUs should not occur between updating the current and next keys. So, Equation 7 is derived for n=0 and t=tₚ.

SI=e^{-λt}^{ₚ} Equation 7

In the Poisson process, λ represents the mean of the number of every possible attack upon the SCADA network. However, the target of attacks may be restricted to the keys in the RTUs. Then, the reason for attacks may be separated into either a logical error of the scheme to update the keys in the RTUs or an error of implementation. Some examples of attacks caused by logical errors are forward secrecy, backward secrecy and so on. Attacks caused by an error of implementation may be separated into invasive attacks on RTUs and non-invasive attacks on RTUs. An example of an invasive attack on the RTUs is reverse engineering of the hardware module of the RTUs. An example of a non-invasive attack on the RTUs is a side channel attack or reverse engineering of the software in the RTUs.

SI is recalculated in Equation 8.

SI=e^{-(λ}^{ₗ}^{+λ}^{ᵢ}^{+λ}^{ₙᵢ}^{)t}^{ₚ} Equation 8

Here, λₗ is the mean of the number of successful attacks caused by logical errors, λᵢ is the mean of the number of successful invasive attacks and λₙᵢ is the mean of the number of successful non-invasive attacks caused by an error in implementation. However, the invention has some logical errors according to the security analysis. So, λₗ of the invention may be assigned to 0.

Finally, the QoS function may be expressed by tₚ.

$$QoS = \frac{T - k / {t}_{p}}{T} + {e}^{- ( {λ}_{l} + {λ}_{i} + {λ}_{ni} ) {t}_{p}} \qquad Equation 9$$

To maximize the QoS function, a differentiation of the Qos function at a tₚ should be 0.

$$\frac{d QoS ( {t}_{p} )}{d {t}_{p}} = \frac{k}{{Tt}_{p}^{2}} - {λ}_{l} + {λ}_{i} + {λ}_{m} {e}^{- ( {λ}_{l} + {λ}_{i} + {λ}_{ni} ) {t}_{p}} \qquad Equation 10$$

Thus, the optimal period for updating the key in the RTUs may be found.

Next, the effect of the invention will be described in detail

The cost of the invention is estimated and analyzed. Here, we are interested in two aspects. (1) The communication time delay should be less than 0.540 seconds. (2) The number of keys stored in an MTU should be less than the previous schemes. The analysis environment is assumed to be as follows.
The number of MT: 33
The size of a Diffie-Hellman parameter p: 1024 bit
The size of a Diffie-Hellman parameter q: 160 bit
The runtime of exponentiation: 0.00008 s
The runtime of RSA-1024 signing: 0.00148 s
The runtime RSA-1024 verification: 0.00007 s
The runtime AES-128/CBC: 0.000009 s
The signature algorithm: RSA 1024 Signature
The certificate format: X.509 v3

Here, Diffie-Hellman parameters p and q are chosen. For run time, Crypto++ 5.6.0 is referenced. RSA and X.509 v3 are also chosen since they are the most commonly used public key cryptosystem scheme and certificate format.

In general, the message size of a SCADA system is less than 1000 bits. Thus, the message encryption/decryption time is 0.000018 s. The group setup time is 0.00015 s because the group key setup phase has 1 exponentiation operation and 1 verification operation. Therefore, the sum of these values and transmission time is the total time delay.

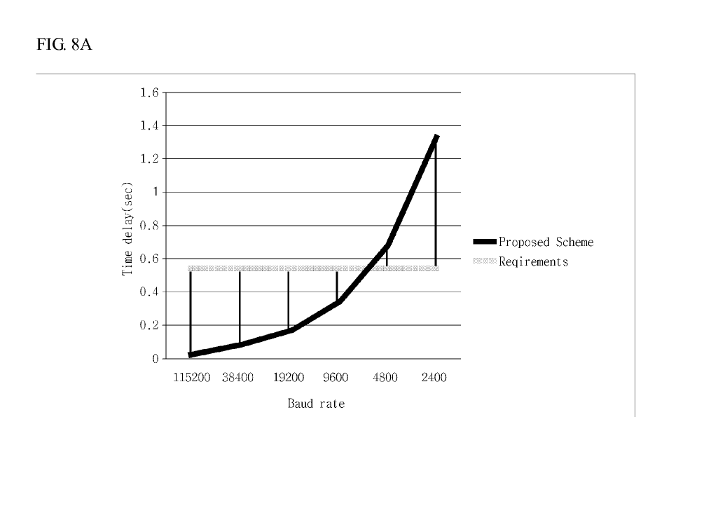

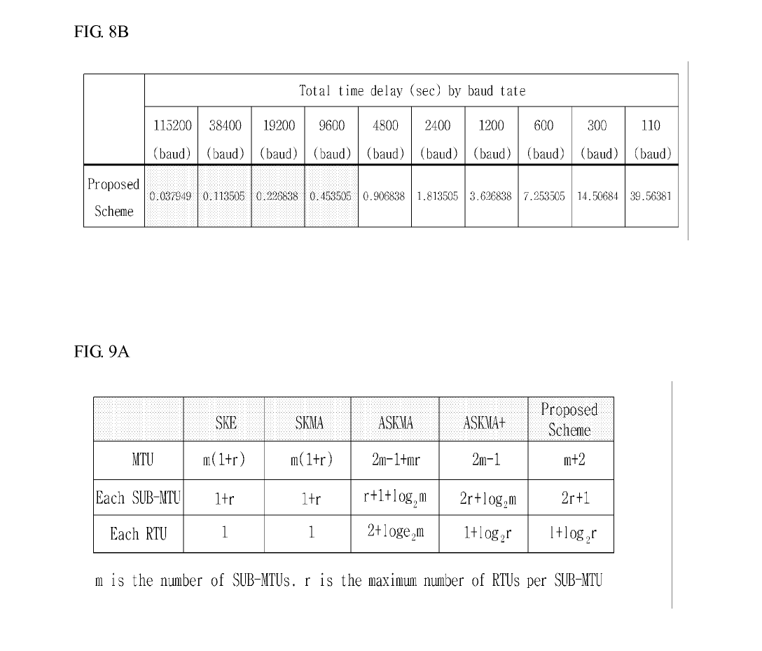

FIG. 8 shows the total time delay according to an embodiment of the invention. The example of the invention satisfies the performance requirements because the total delay time is 0.333505 sec at 9600 baud.

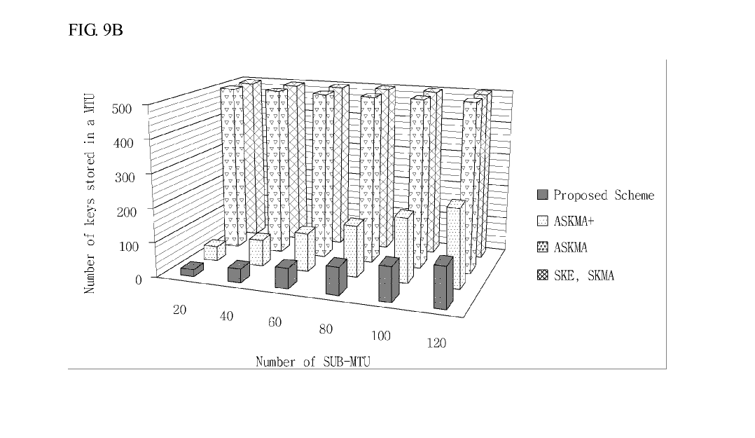

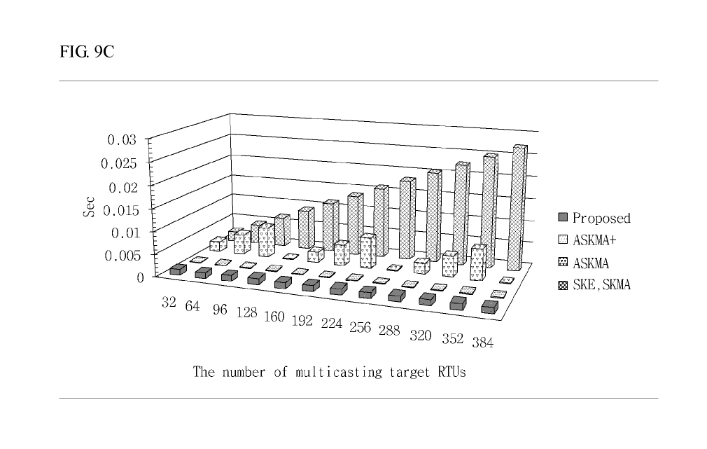

In the invention, the number of keys stored in an MTU is less than that in the other schemes. In FIG. 9A, the number of keys stored in an MTU for SKE, SKMA, ASKMA, ASKMA+, and the proposed scheme is compared.

FIG. 9B compares the number of keys stored in an MTU (r=128).

FIG. 9C compares the total computational time based on the number of multicast target nodes with 5-kb messages (r=128 and m=4).

Next, the security analysis for the proposed scheme will be described.
1) Group key secrecy: the difficulty of an active attacker (Mallory) to compute the group key will be described. Mallory can eavesdrop on, insert, delete, or modify messages on the group communication, but she is not a group member and hence does not know any key, because our protocol relies on the Decision Diffie-Hellman assumption and the Discrete Logarithm Problem. Mallory cannot find any information about the group key and plaintext from ciphertext with non-negligible probability. Therefore, Mallory cannot do better than a brute force search.
2) Forward secrecy: It is assumed that Mallory was a group member during some previous time period and she knows a group key. When Mallory leaves the group, our scheme updates keys as discussed above. Hence, Mallory cannot do better than a brute force search, to compute the new keys.
3) Backward secrecy: When Mallory joins the group and receives a group key, Mallory might have recorded earlier data packets encrypted with previous keys, but the probability of Mallory deriving any previous group keys is negligible because our protocol uses a new group key when Mallory joins the group. Therefore, she cannot derive previous keys by any better means than a brute force search of negligible possibilities to update keys.
4) Key freshness: Session keys are made by hashing a time variant parameter and key. Because a cryptographically secure hash function is used, each section key is independent of the previous key. In addition, all encryption keys are replaced with a new key for each session. Therefore, our protocol guarantees key freshness.
5) Perfect forward secrecy: Perfect secrecy means that a passive adversary who knows a contiguous subset of old group keys cannot discover subsequent group keys. Since the proposed scheme does not have long-term secrets which are used for encryption, the attacker cannot discover subsequent group keys by any better means than a brute force attack.
6) Availability: The proposed scheme supports a replace protocol. The replace protocol operates when the main device breaks down and switches to a backup device allowing a SCADA system to operate continuously. Therefore, the proposed scheme provides availability.

It will be apparent to those skilled in the art that various modifications can be made to the above-described exemplary embodiment of the invention without departing from the spirit or scope of the invention. Thus, it is intended that the invention covers all such modifications provided they come within the scope of the appended claims and their equivalents.

What is claimed is:

1. A hybrid key management method for a supervisory control and data acquisition (SCADA) system in which a master terminal unit (MTU), a plurality of sub-master terminal units (sub-MTUs), and a plurality of remote terminal units (RTUs) are sequentially and hierarchically structured, the hybrid key management method comprising the steps of:
(a) creating, by the MTU and the sub-MTUs, their own secret numbers and making and exchanging digital signatures;
(b) creating, by the MTU, group keys; and
(c) distributing, by the MTU, the group keys to the sub-MTUs and encrypting and decrypting the group keys using the secret numbers.

2. The hybrid key management method of claim 1, wherein step (c) comprises the steps of:
(c1) raising, by the MTU, the group keys to the power of the product of its own secret key and the secret keys of the sub-MTUs and transmitting the raised group keys to the sub-MTUs; and
(c2) decreasing, by the sub-MTUs, the raised group keys in proportion to the inverse power of the product of their own secret keys and the secret key of the MTU to obtain the group keys.

3. The hybrid key management method of claim 2, further comprising the step of:
(d) distributing, upon joining of a new sub-MTU (hereinafter, joining terminal), a group key to the joining terminal,
wherein step (d) comprises the steps of:
(d1) creating, by the joining terminal, its own secret number;
(d2) encrypting, by the MTU and the joining terminal, their secret numbers using a certificate and exchanging the secret numbers; and
(d3) transmitting, by the MTU, the group key to the joining terminal using the same method as step (c).

4. The hybrid key management method of claim 3, further comprising the step of:
(e) redistributing, upon leaving of at least one sub-MTU, the group keys,
wherein step (e) comprises the step of:
(e1) recreating the group keys by the MTU; and
(e2) transmitting, by the MTU, the recreated group keys to the sub-MTUs which have not left according to the same method as step (c).

5. The hybrid key management method of claim 4, further comprising the step of:
(f) replacing, upon exchange of the at least one sub-MTU (hereinafter, exchanged terminal) with another sub-terminal, the group key,
wherein step (f) comprises the steps of:
(f1) recreating the group keys and transmitting the recreated group keys to the sub-MTUs that have not been exchanged according to the same method as step (e); and
(f2) transmitting the recreated group keys to the exchanged terminal by the MTU according to the same method as step (d).

6. The hybrid key management method of anyone of claims 1 to 5, wherein the terminals verify the secret numbers of their counterparts using the certificates of their counterparts.

7. The hybrid key management method of any one of claims 1 to 5, wherein the secret numbers are created by raising generators of a subgroup of an algebraic group to the power of random numbers which are created at random and pertain to the algebraic group.

8. The hybrid key management method of claim 8, wherein the secret numbers are created by applying Equation 1.
Secret number=|g^{r}^{ᵢ} mod p Equation 1
where rᵢ Z_{q} is a random number of a terminal (i=0 in case of an MTU and i=[1,m](m is the number of sub-MTUs) in case of a sub-MTU), g is a generator of a subgroup of an order q, and p is a prime number satisfying p=k·q+1 for a given small number k N.

9. The hybrid key management method of claim 8, wherein an intermediate key IKᵢ is obtained by raising a group key K_{g} to the power of g^{r}^{₀}^{r}^{ᵢ} in Equation 2 and a group key Kg is obtained by decreasing a group key (or intermediate key) IKᵢ to the inverse power of g^{r}^{₀}^{r}^{ᵢ} in Equation 3.
IKᵢ=K^{g}^{^{r}}^{₀}^{^{r}}^{ᵢ}_{g}mod p Equation 2
K_{g}=K^{g}^{^{r}}^{₀}^{^{r}}^{ᵢ}^{/g}^{^{r}}^{₀}^{^{r}}^{ᵢ} mod p Equation 3

10. The hybrid key management method of any one of claims 1 to 5, wherein the group keys have a tree structure, the tree structure has a tree of an n^{th} order from the root node corresponding to the MTU and the intermediate nodes corresponding to the sub-MTUs, the descendent nodes of the intermediate nodes have binary trees, and the leaf nodes of the binary trees correspond to the RTUs connected to the sub-MTUs of the intermediate nodes.

11. A session key generation method using a hybrid key of a supervisory control and data acquisition (SCADA) system in which a master terminal unit (MTU), a plurality of sub-master terminal units (sub-MTUs), and a plurality of remote terminal units (RTUs) are sequentially and hierarchically structured, the session key generation method comprising the steps of:
(a) creating group keys in a tree structure by the MTU, the tree structure having a tree of an n^{th} order from the root node corresponding to the MTU and intermediate nodes corresponding to the sub-MTUs, child nodes of the intermediate nodes having binary trees, and leaf nodes of the binary trees corresponding to the RTUs connected to the sub-MTUs of the intermediate nodes;
(b) distributing the group keys to the sub-MTUs and the RTUs by the MTU and receiving and storing, by the sub-MTUs and the RTUs, the group keys of the ancestor nodes and descendent nodes of the nodes corresponding thereto;
(c) selecting a node of the tree structure and creating a session key for communications with a sub-MTU or an RTU corresponding to the descendent node of the selected node as a group key of the selected node; and
(d) in step (b), creating, by the MTU and the sub-MTUs, their secret numbers and digitally singing and exchanging the secret numbers, the group keys being encrypted and decrypted by the secret numbers to be distributed.

12. The session key generation method of claim 11, wherein session keys are created by hashing values obtained by combining the group keys, timestamps, and sequence numbers.
